(19) United States
(12) Patent Application Publication
(10) Pub. No.: US 2012/0279683 A1
(43) Pub. Date: Nov. 8, 2012

(54) COOLING APPARATUS FOR COMMUNICATIONS PLATFORMS

(75) Inventors: Susanne Arney, Highland Park, NJ (US); Jen-Hau Cheng, New Providence, NJ (US); John Daly, Tralee (IE); Domhnaill Hernon, Bettystown (IE); Marc S. Hodes, Cambridge, MA (US); Christian Joncourt, Lannion (FR); Paul R. Kolodner, Hoboken, NJ (US); Krishna-Murty Kota-Venkata, Springfield, NJ (US); Alan Lyons, New Providence, NJ (US); Todd R. Salamon, New Providence, NJ (US); William Scofield, Batavia, IL (US); Maria E. Simon, New Providence, NJ (US); Oliver Taheny, Galway (IE)

(73) Assignee: Alcatel-Lucent USA Inc., Murray Hill, NJ (US)

(21) Appl. No.: 13/101,562

(22) Filed: May 5, 2011

(51) Int. Cl. F28F 13/00; B23P 19/00

(52) U.S. Cl. 165/80.2; 29/428

(57) ABSTRACT

An apparatus comprising a rack having one or more shelves, a plurality of electronics circuit boards and heat conduits and a cooler. Each board is held by one of the one or more shelves, some of the boards having a localized heat source thereon. Each heat conduit forms a heat conducting path over and adjacent to a particular one of the boards from a region adjacent to the heat source thereon to a connection zone, the zone being remote from the heat source. The cooler is located on a side of the rack and coupled to the zones such that heat is transferable from the paths to the cooler. The cooler is configured to flow a cooling fluid therein to cool localized thermal interfaces at the cooler, each interface being adjacent to and at a corresponding one of the zones.

### ACKNOWLEDGEMENT OF GOVERNMENT SUPPORT

This disclosure was made with government support. The Government has certain rights in the invention.

### TECHNICAL FIELD

The present invention is directed, in general, to a cooling apparatus and, more specifically, to a cooling apparatus used to cool rack-mounted telecommunications or other data circuit boards, and methods for operating and manufacturing the same.

### BACKGROUND

Advances in telecommunication computing architectures are beginning to push the limits of adequate cooling achievable inside of electronic equipment racks using existing air-cooling solutions. Additionally, there are significant increases in acoustic noise and cabinet weight associated with providing adequate air cooling using increased numbers of, or larger more powerful, cooling fans. It is desirable to reduce, or eliminate, the need for such air-cooling equipment.

### SUMMARY

One embodiment includes an apparatus. The apparatus comprises a rack having one or more shelves, and a plurality of electronics circuit boards, each electronics circuit board being held by one of the one or more shelves, some of the electronics circuit boards having a localized heat source thereon. The apparatus also comprises a plurality of heat conduits, each heat conduit forming a heat conducting path over and adjacent to a particular one of the electronics circuit boards from a region adjacent to the localized heat source thereon to a connection zone, the connection zone being remote from the localized heat source thereon. The apparatus further comprises a cooler being located on a side of the rack and coupled to the connection zones such that heat is transferable from the heat conducting paths to the cooler. The cooler is configured to flow a cooling fluid therein to cool localized thermal interfaces at the cooler, each localized thermal interface being adjacent to and at a corresponding one of the connection zones.

Another embodiment is a method of assembling an apparatus. The method comprises providing a rack having one or more shelves. The method also comprises installing electronics circuit boards on the one or more shelves such that each electronics circuit board is held on the one of the one or more shelves. Each electronics circuit board has a localized heat source thereon. Each particular installed electronics circuit board has at least one heat conduit having a portion adjacent to and coupled to a region of the localized heat source thereon and forming a heat conducting path over the particular installed electronics circuit board from the region to a remotely located connection zone adjacent to the particular installed electronics circuit board. The installed electronics circuit boards are located such that each connection zone is adjacent to a corresponding thermal interface of a cooler. The cooler is located on a side of the rack such that heat is transferable from the each connection zone to the adjacent thermal interface, the cooler being configured to flow a cooling fluid therein to cool the thermal interfaces.

### BRIEF DESCRIPTION OF THE DRAWINGS

The embodiments of the disclosure are best understood from the following detailed description, when read with the accompanying FIGURES. Some features in the figures may be described as, for example, “top,” “bottom,” “vertical” or “lateral” for convenience in referring to those features. Such descriptions do not limit the orientation of such features with respect to the natural horizon or gravity. Various features may not be drawn to scale and may be arbitrarily increased or reduced in size for clarity of discussion. Reference is now made to the following descriptions taken in conjunction with the accompanying drawings, in which:

FIG. 1 presents a perspective view of an example apparatus of the present disclosure;

FIG. 2 presents a plan view of a circuit board of the example apparatus along view line 2 shown in FIG. 1;

FIG. 3 shows a side view of a portion of the example apparatus along view line 3 shown in FIG. 1; and

FIG. 4 presents a flow diagram illustrating an example method for assembling an apparatus of the disclosure e.g., the any of the example apparatuses of FIGS. 1-3.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

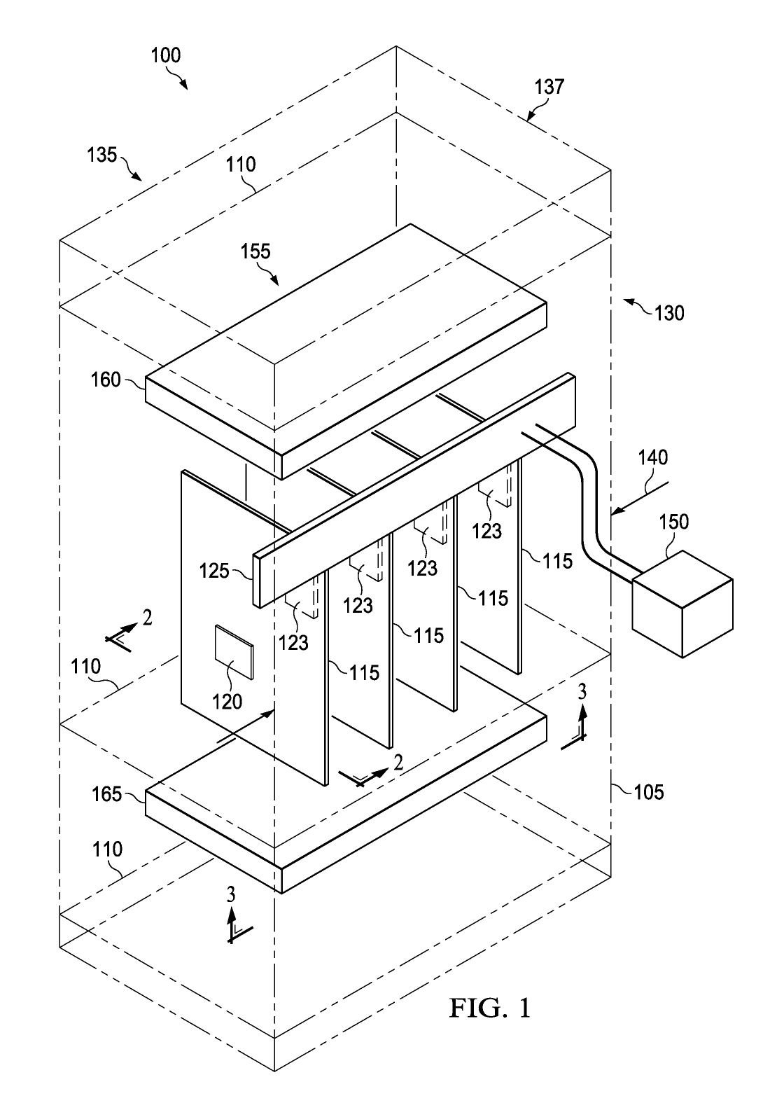

One embodiment of the disclosure is an apparatus. FIG. 1 presents a perspective view of an example apparatus 100 of the present disclosure. The apparatus 100 comprises a rack 105 having one or more shelves 110 (e.g., a row of shelves in some cases), each of the shelves 110 holding one or more electronics circuit boards 115 (e.g., circuit packs), at least some (and in some cases all) of the circuit boards 115 having a localized heat source 120 (e.g., central processing units) thereon.

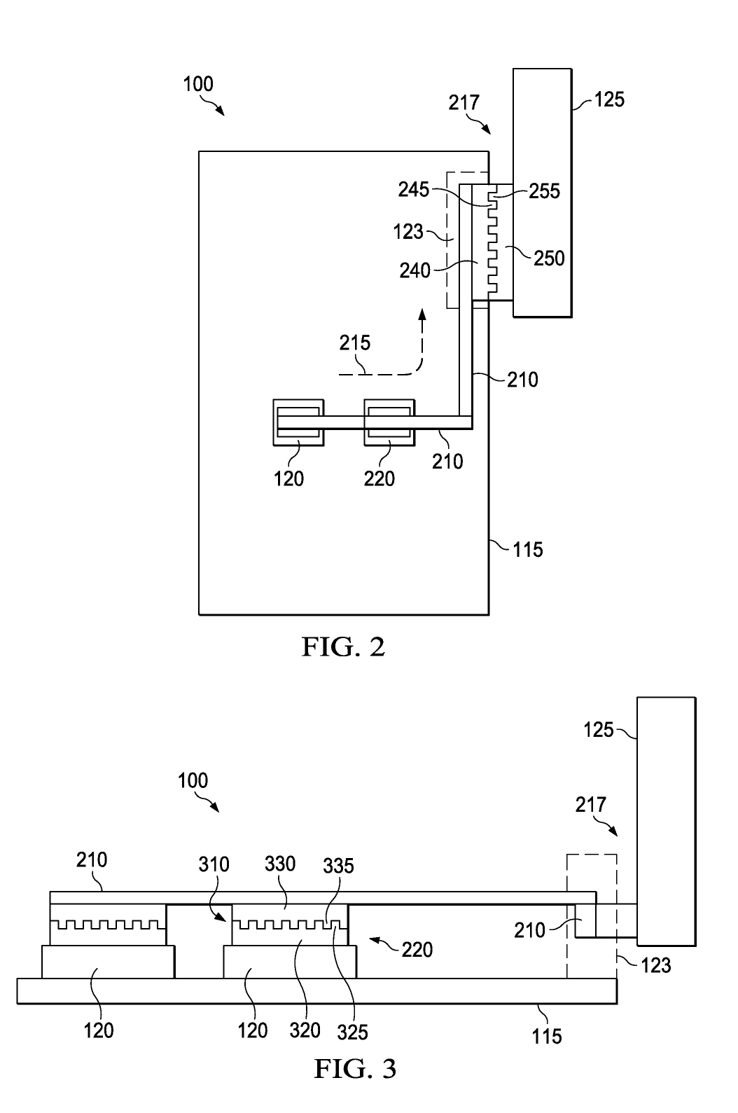

FIG. 2 presents a plan view of a circuit board 115 held in the example apparatus 100 shown in FIG. 1, along view line 2 shown in FIG. 1. As shown in FIG. 2, the apparatus 100 also comprises one or more heat conduits 210 (e.g., heat spreaders and/or heat pipes). As illustrated in FIGS. 1 and 2, each heat conduit 210 forms a heat conducting path 215 over and adjacent to a particular one of the electronics circuit boards 115 from a region adjacent to the localized heat source 120 thereon to a connection zone 123, the connection zone 123 being remote from the localized heat source 120 thereon. In some cases, the connection zone 123 can be on the circuit board 115, while in other cases, the connection zone 123 can be over the circuit board 115. In still other cases, the connection zone can be adjacent an edge of the one of the circuit boards 115. The connection zone is remote from the localized heat source 120,

As further illustrated in FIGS. 1 and 2), the apparatus 100 also comprises a cooler 125 located on a side of the rack 105 and coupled to the connection zones 123 (e.g., thermo-mechanically connected) such that heat is transferable from the heat conducting paths 215 to the cooler 125. The cooler 125 is configured to flow a cooling fluid therein to cool localized thermal interfaces 217 at the cooler 125, each localized thermal interface 217 being adjacent to, and at (e.g., coupled to directly or indirectly but still near) a corresponding one of the connection zones 123.

The term remote as used herein means that substantial amounts of heat are not transferred directly from the heat sources 120 to the portion of a cooler 125 in the vicinity of the connection zone 123. For instance, in some cases, the heat source 120 and connection zone 123 can be separated by a distance of at least 1/10 or more, or ¼ or more than a length of the circuit board 115

The use of the heat conduits 210 and the cooler 125 in this configuration can obviate the need to use large heat sinks that would otherwise occupy a substantial area of the circuit board 115 and have a higher-than-desired vertical profile above the circuit board 115 (e.g., the heat conduits 210, configured as flatten heat pipes, can have low vertical profiles of about 14 mm or lower in some cases). In some embodiments, the use of the heat conduits 210 and the cooler 125 can also mitigate the use of large fans to blow air directly over the circuit boards 115 holding the heat sinks to adequately remove heat from the heat sinks. The presence of components (e.g., heat sinks, power converters and capacitors) having different larger vertical profiles on the circuit board 115 can disrupt the incoming airflow and reduce the heat transfer efficiency of the heat sinks, thereby requiring the use of large high speed fans to provide adequate air flow, thereby increasing acoustic noise and energy consumption.

Some preferred embodiments of the cooler 125 are constructed of materials having a low thermal resistance (e.g., less than about 10 W per ° C.), such as aluminum or copper. As shown in FIG. 1, some embodiments of the cooler 125 are shaped as linear bars (e.g., having a substantially rectangular prism shape) although other shapes can be used to facilitate coupling to the connection zone 123 and efficient interior space utilization of the rack 105. In some cases, the cooler 125 can be shaped and oriented to facilitate efficient coupling to each of the connection zones 123 of each circuit board 115 on a shelf 110 or multiple shelves 110.

In some cases, the cooler 125 can be located at or near a backside 130 of the rack 105 (e.g., analogous to an electrical backplane), while in other cases the cooler 125 can be located at or near a front side 135 of the rack 105, or the top side 137 of the rack 105. The cooler 125 can be located on the inside or the outside of the rack 105. Based on the present disclosure, one of ordinary skill in the art would appreciate that locating the cooler 125 on a side of the rack 105 could including positioning in various other locations and orientations inside or outside of the rack 105 to facilitate coupling to the connection zone 123 and efficient transfer of heat from the heat conduits 210 to the cooler 125 and from the cooler 125 out of the rack 105. For instance, in some embodiments the cooler 125 can be positioned inside of the rack 105 within a slot of the rack 105 configured to hold a circuit pack, or within existing service areas, of certain legacy racks 105. For instance, in some embodiments, the cooler 125 is preferably located above a mid-level 140 of the rack 105 (e.g., between two shelves 110) because such location can facilitate the removal of heat from the rack 105.

As noted, the cooler 125 is configured to circulate a cooling fluid therein to cool a localized thermal interface 217 at the cooler 125 that is coupled to the connection zone 123. In some cases, the cooling fluid is a liquid, while in other cases the cooling fluid is gaseous, while in other cases the cooling fluid can be a liquid or a gas. In some cases, the cooler 125 can be part of a liquid-cooled heat exchanger 150. Some embodiments of the cooler 125 can include a micro-channel heat exchanger, such as disclosed in U.S. patent application Ser. No. 12/011,402, which is incorporated by reference herein in it entirety.

Example embodiments of the cooler 125 include heat pipes, heat spreaders, or vapor chambers. In some cases, the cooler 125 is composed of one or more heat pipes. In some preferred embodiments, for example, the cooler 125 can include an assembly of heat pipes because of their low cost, reliable operation, flexibility of design (e.g., the ability to be curved and made flat) and because of their ability to move significant quantities of heat without any moving parts.

In some embodiments, some of the localized thermal interfaces 217 include a heat pipe or a vapor chamber adjacent to the corresponding ones of the connection zones 123.

In some embodiments, the cooler 125 may include one or more heat spreaders and/or heat pipes that are cooled by an air-flow heat exchanger 155 located in of near the rack 105. The air-flow heat exchanger 155 can be configured to remove heat from one or more of the cooler 125, the heat conduits 210 or localized thermal interface 217. In some cases, for example, the air-circulating heat exchanger 155 includes a fan tray 160 that is situated above the shelf 110 holding the circuit boards 115 and is configured to pull air over the surface of the cooler 125. In some cases, for instance, the air-circulating heat exchanger 155 can include a fan tray 165 that is situated below the shelf 110 holding the circuit boards 115 and configured to push air over the surface of the cooler 125. In some case the air-circulating heat exchanger 155, includes two fan trays 160, 165 arranged in an air push-pull configuration. Based on the present disclosure variation of the air-circulating heat exchanger 155, would be apparent to one or ordinary skill in the art.

In some embodiments, as shown in FIG. 1, the connection zone 123 can be adjacent an edge of the one of the circuit boards 115. For example, the connection zone 123 can be in a corner of the circuit board 115 located remote from the heat sources 120 on the circuit board 115, although in other cases, the connection zone 123 can be in a central location on the circuit board 115. Locating the connection zone 123 can also facilitate coupling to the cooler 125. In some cases it is preferable for all the connection zones 123 of each of the circuit boards 115 to be in a same location on the circuit board 115 to facilitate the use of a common mechanism of coupling to the cooler 125 and to facilitate the interchangeability of circuit boards 115.

In some preferred embodiments, the localized thermal interface 217 at the cooler 125 that is coupled to the connection zone 123 includes detachable thermal couplers. The detachable thermal couplers can include any of the heat transfer devices, but configured for detachability, as disclosed in U.S. patent application Ser. No. 10/946,571 to Ewes et al. filed Sep. 21, 2004, which is incorporated by references herein in its entirety. In some preferred embodiments, the detachable thermal couplers include interleaved fin structure. Advantages of such thermal couplers include: compliance between different components heights and as such can replace the use of thicker (e.g., 4 mm in some cases) thermal interface materials between the heat source 120 and the heat sink as used in some circuit pack designs; three degrees of freedom, two translational and one rotational, giving these thermal connectors flexibility in their use; low thermal resistances; their thermal properties are well understood; and low cost.

FIG. 2 shows aspects of an example localized thermal interface 217. In some cases, as shown in FIG. 2, the connection zone 123 can include a first thermal coupler 240 having metal fin structures 245 and the localized thermal interface 217 at the cooler 125 can include a second thermal coupler 250 having metal fin structures 255. The metal fin structures 245, 255 of the first and second thermal couplers 240, 250 can interleave with each other to form the thermal interface 217. The thermal interface 217 can be detachably connected to the cooler 125 or the heat conduit 210 in the connection zone 123.

In some preferred embodiments, the heat conduits 210 are made of a material having a low thermal resistance (e.g., less than about 10 W per ° C.). In some cases the heat conduits 210 are solid throughout and composed of low thermal resistance materials such as metals, or other suitable heat conducting materials well know to those skilled in the art. In some cases, the heat conduit 210 can be a rigid structure, while in other cases the heat conduit 210 can be a flexible structure, e.g., to facilitate adaptation to various existing platforms of circuit boards 115.

In some preferred embodiments, the heat conduits 210 are heat pipes, each heat pipe having a sealed chamber therein, the sealed chamber including a coolant fluid therein. One of ordinary skill would be familiar with the types of materials and fluids and appropriate fluid vapor pressure inside of the sealed chamber to facilitate efficient heat transfer through the heat pipes. To mitigate refrigerant fluid leaking onto the circuit board 115, the heat conduits 210 configured as heat pipes can be closed structures. For example, the heat conduits 210 configured a heat pipes can be constructed to not exchange cooling fluid with the cooler 125.

FIG. 3 shows a side view of a portion of the example apparatus 100 along view line 3 shown in FIG. 1. In some preferred embodiments, as illustrated in FIG. 3, the heat conduits 210 are configured as flattened heat pipes so as to minimize their vertical profile (e.g., about 0.5 to 1 mm in some cases) on the circuit board 115. Some embodiments of the heat conduits 210 can be shaped as straight bars and be connected together to form the heat path 215. Other embodiments of the heat conduits 210 can have more complex shapes (e.g., curvatures to bend around other components on the circuit board 115) to allow the heat conduit 210 to be adjacent to multiple heat sources 120 on the circuit board 115 as part of forming the heat path 215.

As further illustrated in FIG. 3, in some embodiments, one or more of the heat conduits 210 can be mechanically detachably connected to the region 220 adjacent to the localized heat source 120. For instance, similar to the localized thermal interface 217 at the cooler 125 that is detachably coupled to the connection zone 123, there can be a second detachable localized thermal interface 310 between the region 220 adjacent to the heat source 120 and the heat conduit 215. For instance, the region 220 can include a third thermal coupler 320 having metal fin structures 325 and a fourth thermal coupler 330 having metal fin structures 335. The metal fin structures 325, 335 of the third and fourth thermal couplers 320, 330 can interleave with each other.

In some embodiments, one or more of the heat conduits 210 can also be configured to be mechanically detachably connected to both the connection zone 123 and the region 220, e.g., to facilitate replacement of the heat conduit 210 with a different heat conduit 210.

In other cases, however, the heat conduits 210 can be permanently fixed to the thermal interface 217 at the cooler 125 or to the region 220 adjacent to the heat source 120. A permanent fixture (e.g., a solder bond) can provide the advantage of reducing the thermal resistance and improving the overall heat transfer. In such cases the circuit boards 115 can be removed by disconnecting at the thermal interface 217 such as discussed above. In still other cases one of the heat conduits 220 can directly contact the heat source 120. In such cases the adjacent region 220 would be the interface between the heat source 120 and heat conduit 210.

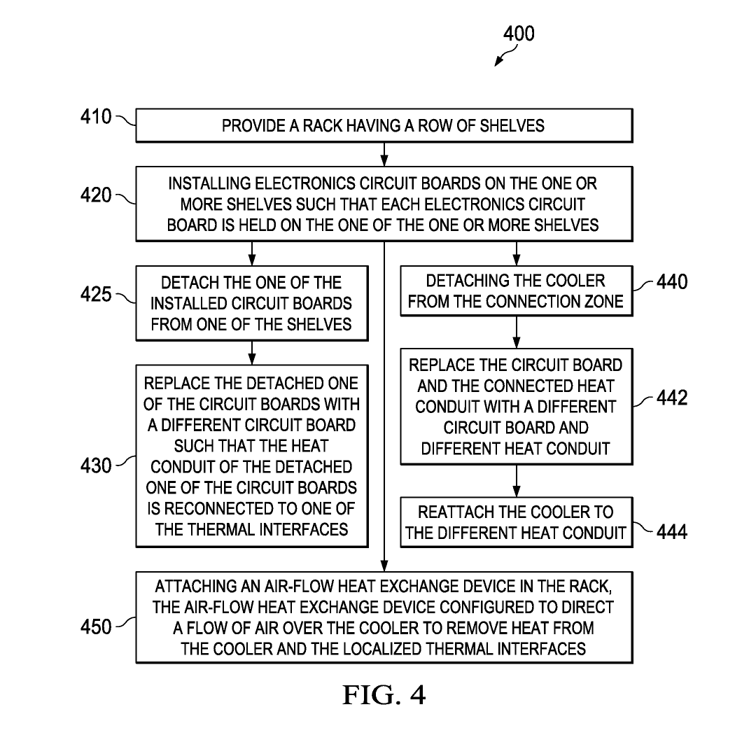

Another embodiment is a method of assembling an apparatus. FIG. 4 presents a flow diagram illustrating an example method 400 for assembling an apparatus of the disclosure. Any of the embodiments of the apparatus 100, and its component parts, discussed herein can be operated in accordance with the method 400.

With continuing reference to FIGS. 1-3 throughout, the method 400 includes a step 410 of providing a rack 105 having one or more shelves 110, and step 420 of installing electronics circuit boards 115 on the one or more shelves 110 such that each electronics circuit board 115 is held on the one of the one or more shelves 110.

Each electronics circuit board 115 has a localized heat source 120 thereon, each particular installed electronics circuit board 115 having at least one heat conduit 210 having a portion adjacent to and coupled (e.g., thermal mechanically connecting) to a region 220 of the localized heat source thereon and forming a heat conducting path 215 over the particular installed circuit board 115 from the region 220 to a remotely located connection zone 123 adjacent to the particular installed circuit board 115. The installed electronics circuit boards 115 are located such that each connection zone 123 is adjacent to a corresponding thermal interface 217 of a cooler 125, the cooler 125 being located on a side (e.g., sides 130, 135) of the rack 105 such that heat is transferable from the each connection zone 123 to the adjacent thermal interface 217, the cooler 125 being configured to flow a cooling fluid (e.g., a one-phase or two-phase refrigerant fluid) therein to cool the thermal interfaces 217.

Some embodiments of the method 400, can include a step 425 of detaching one of the installed circuit boards 115 from one of the shelves 110 such that the heat conduit 210 of the one of the installed circuit boards 115 is uncoupled from the previously adjacent thermal interface 217, and, a step 430 of replacing the detached one of the circuit boards 115 with a different circuit board 115 on the one of the shelves 110 such that the heat conduit 210 of the detached one of the circuit boards 115 is reconnected to one of the thermal interfaces 217.

In such embodiments detaching the cooler 125 from the connection zone 123 in step 425 can include detaching the thermal interface 217. In some such embodiments, the heat conduit 210 can be permanently fixed to the region 220 and the connection zone 123, and therefore the heat conduit 210 is replaced along with the circuit board 115. In other embodiments, the same heat conduit is used to connect to the different circuit board 115. As used herein the term “different circuit board” could refer the same circuit board 115 that was detached in step 425, after it has been inspected, tested or altered (e.g., a component replaced or added).

Some embodiments of the method 400, can include a step 440 of detaching the cooler 125 from the connection zone 123, a step 442 of replacing the circuit board 115 and the connected heat conduit 210 with a different circuit board 115 and different heat conduit 210, and step 444 of reattaching the cooler 125 to the different heat conduit 210.

Some embodiments of the method 400 include a step 450 of attaching an air-flow heat exchange device (e.g., one or both of devices 160, 165) in the rack 105, the air-flow heat exchange device configured to direct a flow of air over the cooler 125 to remove heat from the cooler 125 and/or the localized thermal interfaces 217.

For instance, one or more fan trays 160, 165 can be attached in the rack 105 (e.g., on top of each shelf 110) so as to facilitate pulling, pushing or both pushing and pulling air over the surface of the cooler 125. One of ordinary skill would understand how to position additional components (e.g., air deflectors) in the rack as part of step 450. In some embodiments, the air may not necessarily flow over the cooler 125, but rather the cooler can be attached to the heat conduit 210 and the air will flow over the heat conduit 210. The air can also be configured to flow, e.g., via deflectors, over other components on the board 115 that are not attached to the heat source 120.

Although the present invention has been described in detail, those skilled in the art should understand that they can make various changes, substitutions and alterations herein without departing from the scope of the invention.

What is claimed is:

1. An apparatus, comprising:
a rack having one or more shelves and a plurality of electronics circuit boards, each electronics circuit board being held by one of the one or more shelves, some of the electronics circuit boards having a localized heat source thereon;
a plurality of heat conduits, each heat conduit forming a heat conducting path over and adjacent to a particular one of the electronics circuit boards from a region adjacent to the localized heat source thereon to a connection zone, the connection zone being remote from the localized heat source thereon; and
a cooler being located on a side of the rack and coupled to the connection zones such that heat is transferable from the heat conducting paths to the cooler; and
wherein the cooler is configured to flow a cooling fluid therein to cool localized thermal interfaces at the cooler, each localized thermal interface being adjacent to and at a corresponding one of the connection zones.

2. The apparatus of claim 1, wherein the cooler includes a micro-channel heat exchanger.

3. The apparatus of claim 1, further including an air-flow heat exchange device located in of near the rack configured to remove heat from the localized thermal interfaces.

4. The apparatus of claim 3, wherein the air-flow heat exchange device includes one or more fan trays located inside of the rack.

5. The apparatus of claim 3, wherein one of the localized thermal interfaces and the corresponding one of the connection zones forms a structure, the structure including detachably interleaved metal fins.

6. The system of claim 3, wherein the cooler is composed of one or more heat pipes.

7. The apparatus of claim 1, wherein some of the localized thermal interfaces include a heat pipe or a vapor chamber adjacent to the corresponding ones of the connection zones.

8. The system of claim 1, wherein the cooler is located above a mid-level of the rack.

9. The apparatus of claim 1, wherein some of the localized thermal interfaces include detachable thermal couplers.

10. The apparatus of claim 9, wherein one of the localized thermal interfaces and the corresponding one of the connection zones forms a structure, the structure including detachably interleaved metal fins.

11. The apparatus of claim 1, wherein one of the heat conduits include heat pipes thermally coupled to physically remote localized heat sources located on a particular one of the electronics circuit boards.

12. The apparatus of claim 1, wherein at least one of the heat conduits is mechanically detachably connected to the region adjacent to the corresponding one of the localized heat sources.

13. A method of assembling an apparatus, comprising:
providing a rack having one or more shelves;
installing electronics circuit boards on the one or more shelves such that each electronics circuit board is held on the one of the one or more shelves, each electronics circuit board having a localized heat source thereon, each particular installed electronics circuit board having at least one heat conduit having a portion adjacent to and coupled to a region of the localized heat source thereon and forming a heat conducting path over the particular installed electronics circuit board from the region to a remotely located connection zone adjacent to the particular installed electronics circuit board; and
wherein the installed electronics circuit boards are located such that each connection zone is adjacent to a corresponding thermal interface of a cooler, the cooler being located on a side of the rack such that heat is transferable from the each connection zone to the adjacent thermal interface, the cooler being configured to flow a cooling fluid therein to cool the thermal interfaces.

14. The method of claim 13, further including:
detaching one of the installed circuit boards from one of the shelves such that the heat conduit of the one of the installed circuit boards is uncoupled from the previously adjacent thermal interface;
replacing the detached one of the circuit boards with a different circuit board on the one of the shelves such that the heat conduit of the detached one of the circuit boards is reconnected to one of the thermal interfaces.

15. The method of claim 13, further including:
detaching the cooler from the connection zone;
replacing the circuit board and the connected heat conduit with a different circuit board and different heat conduit; and
reattaching the cooler to the different heat conduit.

16. The method of claim 13, wherein the cooler is installed at a mid-level of the rack.

17. The method of claim 13, further including attaching an air-flow heat exchange device in the rack, the air-flow heat exchange device configured to direct a flow of air over the cooler to remove heat from the cooler and the localized thermal interfaces.

18. The method of claim 18, wherein the air-flow heat exchange device includes one or more fan trays configured to pulled air over the cooler and the localized thermal interfaces.

19. The method of claim 18, wherein attaching an air-flow heat exchange device in the rack includes installing two fan trays in the rack such that one fan tray is configured to push air over the cooler and the other fan tray is configured to pull air over the cooler.

20. The method of claim 17, wherein the cooler is composed of one or more heat pipes.
